(19) United States
(12) Patent Application Publication
(10) Pub. No.: US 2018/0192656 A1
(43) Pub. Date: Jul. 12, 2018

(54) Heating Device For A Foodstuff Press

(71) Applicant: BSH HAUSGERAETE GMBH, MUENCHEN (DE)

(72) Inventors: KAY-UWE CLEMENS, HAAG IN OBERBAYERN (DE); THOMAS GARBE, OTTOBRUNN (DE); LUCIA SCHUSTER, MUENCHEN (DE); ISABELLA STADTMANN, ULM (DE)

(21) Appl. No.: 15/742,132

(22) PCT Filed: Jul. 4, 2016
(86) PCT No.: PCT/EP2016/065650

§ 371 Date: Jan. 5, 2018

(30) Foreign Application Priority Data
Jul. 7, 2015 (DE) 10 2015 212 644.7

(51) Int. Cl. A21C 11/16; A23P 30/20

(52) U.S. Cl. CPC A21C 11/16; A23P 2020/253; A23P 30/20

(57) ABSTRACT

A device for a system for producing food includes a movable nozzle which is configured to expel a printable mass in various positions, in order to produce a spatial configuration of the printable mass for food. A movable heating unit is configured to supply thermal energy to the printable mass which has been expelled from the nozzle. A control unit is configured to determine a recipe for producing food. The recipe indicates position data with a plurality of positions at which the printable mass is to be expelled from the nozzle, in order to produce the spatial configuration of the printable mass for the food. In addition, the control unit is configured to move the movable nozzle and the movable heating unit in accordance with the position data.

The invention relates to a device for selectively heating or cooking printable mass for a foodstuff press.

Foodstuff presses enable a user to individually and reliably prepare a plurality of different foodstuffs. For instance, different bakery products can be individualized and produced as required by means of a foodstuff press.

A cooking process (especially a baking process) in a foodstuff press may require a relatively long period of time. Furthermore, the individual production of a foodstuff may cause a relatively high energy consumption. This results in foodstuff presses being suitable only to a limited extent for certain applications (e.g. for the rapid production of an individual pastry in an “automatic pastry machine”).

DE 10 2006 010312 A1 describes a system, in which an injection molding compounder is used for this purpose to shape a foodstuff. DE 34 17 196 A1 describes a system in which an extrudate is pressed into shapes in order to produce shaped food. DE 29 03 091 C1 describes a system for producing network-type foodstuff products. The afore-cited documents do not address the cooking of foodstuffs.

The present document addresses the technical object of providing a device for a foodstuff press, by means of which a cooking process can be accelerated and the energy consumption of a cooking process can be reduced.

The object is achieved by the subject matters of the independent claims.

Advantageous embodiments are inter alia described in the dependent claims and the following description or are shown in the appended drawing.

According to one aspect, a device for a system for producing a foodstuff (e.g. for a foodstuff press) is thus described. The system or the foodstuff press can be used in particular to produce a pastry. The device can be configured to selectively heat or cook printable mass, which is used to produce a foodstuff. The device comprises a movable nozzle, which is configured to expel printable mass at various positions, in order to produce a spatial arrangement of printable mass for a foodstuff. The printable mass typically has a deformable and/or viscous consistency. In particular, the printable mass may comprise a dough for a pastry. The printable mass can be provided in a mixing container and/or in a casing.

The device further comprises a movable heating unit, which is configured to supply thermal energy to the printable mass, which has been expelled from the nozzle, or to warm or heat this printable mass. In particular, the heating unit can be used to heat expelled printable mass in order to cook (in particular to bake) the printable mass. In such cases the heating unit is typically configured to supply thermal energy at a specific point in time only to a fraction of the spatial arrangement of printable mass, in particular only to a spatially localized part of the spatial arrangement of printable mass.

The device moreover comprises a control unit, which is configured to determine a recipe for producing a (specific) foodstuff. The recipe displays position data with a plurality of positions, at which the printable mass is to be expelled from the nozzle, in order to produce the spatial arrangement of printable mass for the (specific) foodstuff. The recipe can also display which type and/or which quantity of printable mass are to be expelled at one position. Furthermore, the control unit is configured to move the movable nozzle and the movable heating unit as a function of the position data.

Moving the heating unit allows expelled printable mass to be cooked selectively. In particular, during processes which run in parallel, it enables printable mass to be expelled via the nozzle and printable mass already expelled to be cooked (in particular baked). Therefore the cooking process can be accelerated and the energy consumption of the cooking process can be reduced.

The movable heating unit can be configured to follow a movement of the movable nozzle. In particular, the heating unit can follow a movement of the nozzle laterally or horizontally with respect to a surface to which the printable mass is applied. In such cases, the heating unit can follow the nozzle at a predefined (lateral) distance. This means that expelled printable mass can be cooked (in particular baked) promptly after being applied to the surface. The cooking process can thus be accelerated.

The movable heating unit can be connected to the nozzle by means of fastening means. This efficiently ensures that the heating unit has a (typically constant) distance from the nozzle. Furthermore, it can be efficiently ensured that printable mass is heated by the heating unit within a specific period of time after expulsion.

The movable heating unit can comprise an actuator (e.g. a motor), with which the heating unit can be moved around the nozzle. The control unit can be configured to determine a direction of movement of the nozzle (especially based on the position data). Furthermore, the control unit can be configured to control the actuator as a function of the direction of movement of the nozzle. In such cases the actuator can be controlled such that the heating unit is always located behind the nozzle in the direction of movement, so that after expulsion of printable mass the expelled printable mass can be heated (and thus cooked) promptly.

The heating unit can be arranged in relation to the nozzle and/or arranged (by the control unit) such that the heating unit follows a movement of the nozzle at a predefined distance. In particular, the heating unit can be moved such that the heating unit is pulled along by the nozzle, like a sliding carriage, behind the nozzle. Furthermore, the heating unit can be arranged in relation to the nozzle and/or arranged (by the control unit) such that the heating unit can supply thermal energy to printable mass which has been expelled from the nozzle within a specific period of time after expulsion of the printable mass. Here the specific period of time typically depends on the speed of movement of the nozzle. On account of such an alignment of the heating unit, prompt cooking of the printable mass can be achieved.

The heating unit can comprise one or more of the following heating elements: a heating plate which can be heated and/or a light source which is configured to emit electromagnetic radiation in the UV (ultraviolet) and/or IR (infrared) range. A heating plate can be used to supply thermal energy to the printable mass across the surface of the printable mass. On the other hand, thermal energy can be supplied to the inside of the printable mass by means of electromagnetic radiation. Different methods for heating the printable mass can thus be provided by the heating unit. The cooking process can thus be accelerated if necessary.

A heating element of the heating unit (in particular a heating plate) which emits heat can have a width which is equal to or greater than a width of a strand of printable mass which is expelled by the nozzle. The width of the heating element can thus be adjusted to the width of a strand of printable mass to be cooked. A selective heating of the expelled strand of printable mass can thus be effected, which is advantageous particularly with respect to the energy consumption. Furthermore, the heating element typically has a length which is greater than the width of the heating element. In such cases the length of the heating element can depend on a predefined (possibly maximum) speed of movement of the nozzle. Typically the length of the heating element should increase with an increasing (maximum) speed of movement of the nozzle. An adequate transfer of thermal energy can therefore be ensured even with relatively high speeds of movement of the nozzle.

The heating unit can have a ring-shaped structure, which encloses the nozzle. Therefore it can be efficiently achieved that the heating unit can heat and thus cook printable mass immediately following the expulsion irrespective of the direction of movement of the nozzle.

The heating unit (in particular a ring-shaped heating unit) can comprise a plurality of heating segments, which can be controlled separately in order to transmit thermal energy to expelled printable mass. In the case of a ring-shaped heating unit the heating segments can be arranged around the nozzle. The control unit can be configured to activate the plurality of heating segments as a function of the position data, in particular as a function of the direction of movement of the nozzle. The selective activation of one or more heating segments may bring about a selective heating of printable mass and a reduction in the energy consumption.

The heating unit (in particular a heating plate of the heating unit) can be configured to heat up air in an area surrounding the heating unit. The device can comprise means of moving heated air from the heating unit to expelled printable mass. The (selective) cooking process can thus be accelerated.

The heating unit can have a (possibly vertical) distance from the expelled printable mass, which is equal to or greater than a (possibly vertical) distance between the nozzle and the expelled printable mass. The distance here can correspond to a distance at right angles to or vertical to the surface to which the printable mass has been applied. The heating unit can be moved by the control unit such that the (possibly vertical) distance fulfills the afore-cited condition. In particular, the distance to the heating unit and the distance to the nozzle may be the same. As efficient as possible a transmission of energy and acceleration of the cooking process can thus be brought about, without affecting the spatial arrangement of printable mass.

The recipe may display one or more parameters for the cooking of printable mass for producing the (specific) foodstuff. The one or more parameters may comprise for instance: a quantity of thermal energy to be supplied to the printable mass; a time instant at which thermal energy is be supplied to the printable mass; and/or a method or a heating element with which thermal energy is to be supplied to the printable mass. The control unit can be configured to control the heating unit as a function of the one or more parameters. The quality of the foodstuff produced can thus be increased.

The device can comprise a cooking unit, which is configured to supply thermal energy to the spatial arrangement of printable mass as a whole. In particular, the cooking unit can comprise a cooking compartment in which the spatial arrangement of printable mass is located. The cooking compartment can be heated overall, in order to cook the spatial arrangement of printable mass as a whole. The cooking process can be further accelerated by providing a cooking unit (for heating a complete spatial arrangement of printable mass) and a heating unit (for selectively heating an individual strand of printable mass from the spatial arrangement of printable mass). The recipe can display information for controlling the cooking unit, and the control unit can be configured to control the cooking unit as a function of the recipe.

According to a further aspect, a system for producing a foodstuff (in particular a foodstuff press) is described, which comprises the device described in this document for selectively heating printable mass.

It should be noted that the devices and systems described in this document can be used both alone and also in combination with other devices and systems described in this document. Furthermore, any aspects of the devices and systems described in this document can be combined with one another in a variety of ways. In particular the features of the claims can be combined with one another in a variety of ways.

The invention will now be described in more detail on the basis of exemplary embodiments shown in the appended drawing, in which:

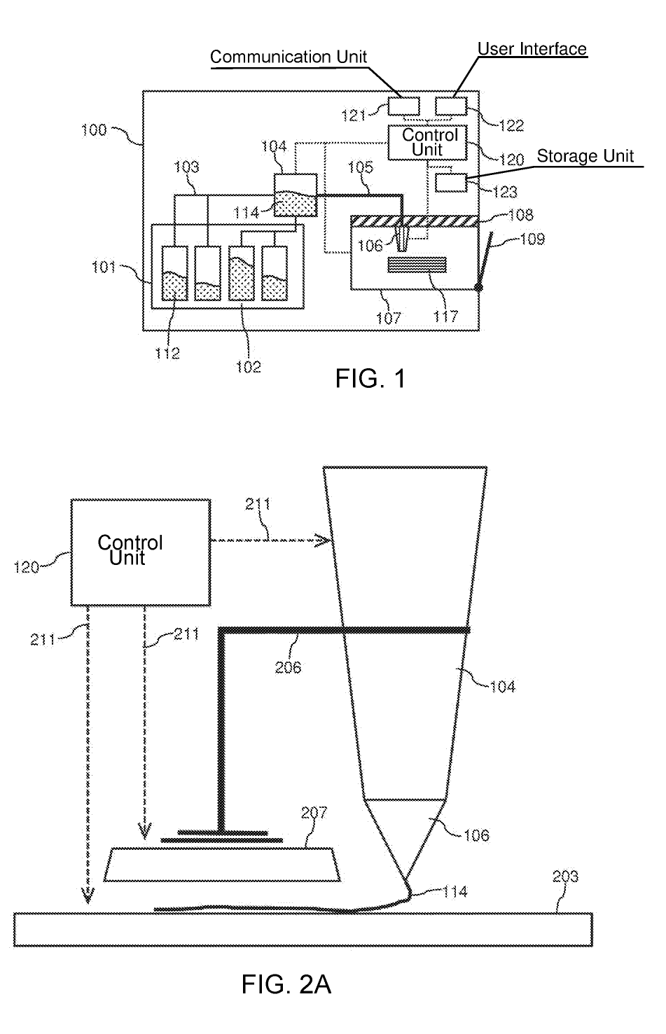

FIG. 1 shows a block diagram of an exemplary system for producing a foodstuff; and

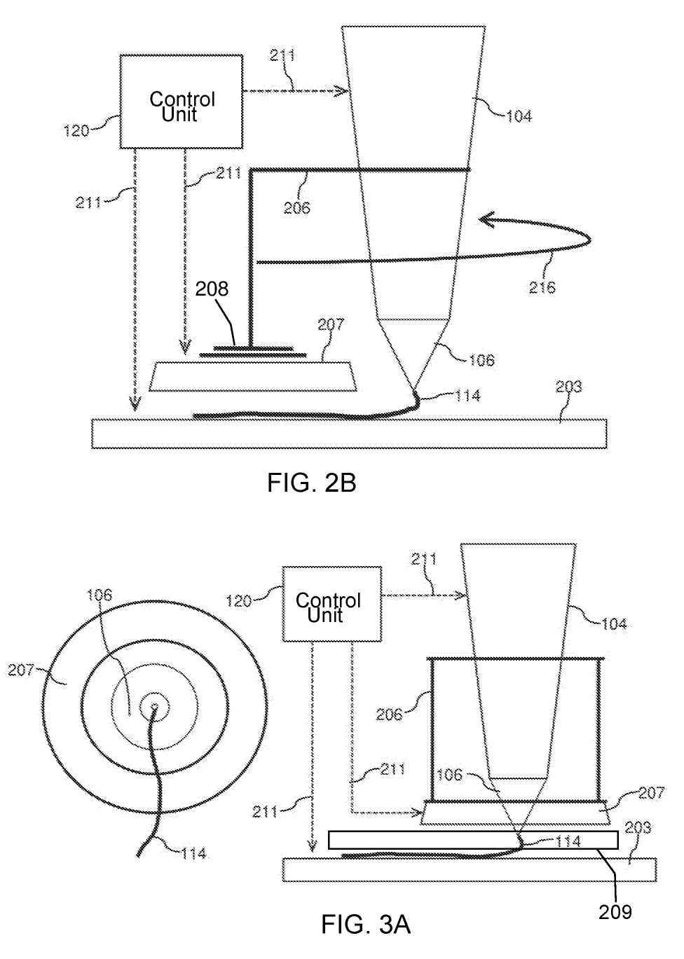

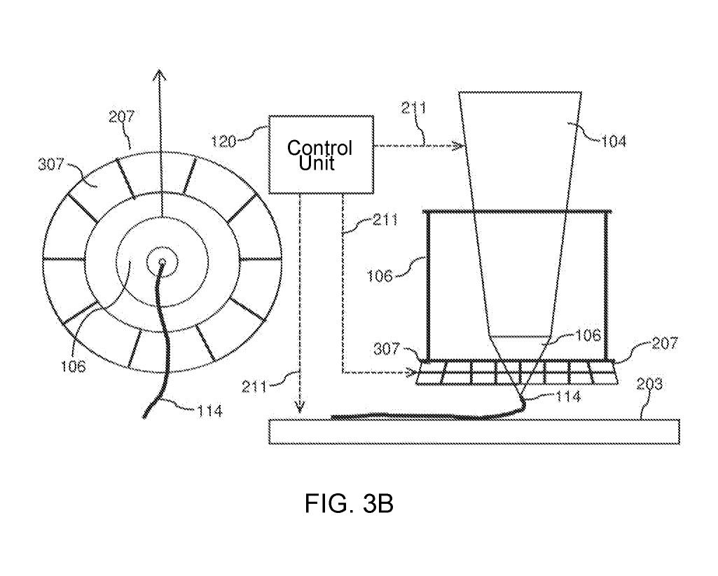

FIGS. 2a, 2b, 3a, 3b show block diagrams of exemplary devices for selectively heating printable mass for a system for producing a foodstuff.

As explained in the introduction, the present document addresses the automatic production of foodstuffs, such as e.g. the automatic production of a pastry. In particular, the present document addresses an efficient heating device for a system for automatically producing foodstuffs.

FIG. 1 shows a block diagram of an exemplary system 100 for producing a foodstuff 117 (e.g. for producing a pastry). The system 100 can comprise one or more containers 102 for receiving a corresponding number of ingredients 112. The one or more containers 102 can be inserted into the system 100 (at positions provided therefor) and the containers 102 can be replaced if necessary. For instance, a container 102 can comprise a casing or a cartridge. The one or more containers 102 can be arranged within the system 100 in a tempering unit 101 (e.g. in a refrigerator). By tempering the one or more containers 102, the shelf life of the ingredients 112 contained therein can be lengthened.

The edible ingredients 112 can have a moldable consistency at least partially. The edible ingredients 112 can be present e.g. at least partially in pureed form and/or as a moldable dough. Furthermore, the ingredients 112 can comprise different components of a foodstuff 117 to be produced. For instance, the ingredients 112 can comprise a dough for a pastry in a first container 102. A second container 102 can contain a fruit component for instance and a third container 102 can contain e.g. a chocolate component. Moreover, sugar can be provided as ingredient 112 in one of the containers 102. Different variants of a pastry (e.g. with different sugar content, with or without chocolate flavor, with or without fruit flavor etc.) can thus be produced using the system 100.

The one or more containers 102 can be connected to a mixing unit 104 via lines 103. One or more ingredients 112 from the one or more containers 102 can be mixed in the mixing unit 104, in order to generate a printable mass 114 for producing the foodstuff 117. The printable mass 114 can be conveyed via a line 105 to a nozzle 106, wherein the nozzle 106 is configured to eject or expel the printable mass 114 in specific positions in order to create a spatial arrangement of printable mass. For instance, different printable masses 114 can be ejected in layers in order to create a spatial arrangement in layers made of the different press masses 114. For this purpose the nozzle 106 can be movably arranged on a rail 108, so that the nozzle 106 can be moved to different positions and can eject printable mass 114 in different positions.

The spatial arrangement produced on the basis of the printable mass 114 can be cooked as a whole by a cooking unit 107 in order to create a ready-cooked (e.g. baked) foodstuff 117. The cooking unit 107 can comprise a thermal oven, a microwave oven, a steamer, a grill and/or a pan. In the example shown in FIG. 1, the spatial arrangement of printable mass 114 is “pressed” directly by the nozzle 106 within the cooking unit 107. This is advantageous since the effort involved in transporting the spatial arrangement to the cooking unit 107 can thus be reduced.

The ready-cooked foodstuff 117 can be output to a user by way of an output 109 of the system 100. In the example shown, the cooking unit 107 comprises a flap 109, by means of which a user can remove the foodstuff 117 from the cooking unit 107.

The system 100 comprises a control unit 120, which is configured to determine a recipe for a foodstuff 117 to be created. For instance, the control unit 120 can access a recipe database on a storage unit 123 of the system 100. Alternatively or in addition, the control unit 120 can access an external recipe database, which is stored on an external server, by way of a communication unit 121. The communication unit 121 can be configured to communicate with the external server by way of a wireless and/or wired network. Alternatively or in addition, the recipe can be provided or selected by way of a user interface 122 (e.g. by way of a touch-sensitive screen) of the system 100) of the control unit 120.

The control unit 120 is also configured to apply quantities of ingredients 112 from the containers 102 (if necessary via the mixing unit 104), determined as a function of the recipe, to the spatial arrangement of printable mass 114 or to the foodstuff 117 to be produced. Furthermore, the control unit 120 can be configured to activate the cooking unit 107 of the system 100 as a function of the recipe, in order to cook the spatial arrangement of printable mass 114 at least partially.

The cooking (in particular the baking) of a completely spatial arrangement of printable mass 114 in a cooking unit 107 may require a relatively long time. Furthermore, the prompt cooking of different printable masses 114 in a cooking unit 107 may result in inadequate results. In FIGS. 2 and 3, exemplary heating units are described for a system 100 for producing a foodstuff 117, by means of which an accelerated and/or an individualized cooking of printable mass 114 is enabled. The heating units shown in FIGS. 2 and 3 may, if necessary, be used in combination with a cooking unit 107.

FIG. 2a shows a nozzle 106 and a mixing unit 104 arranged above the nozzle 106, which mixing unit comprises the printable mass 114, which can be extruded or expelled by way of the nozzle 106. In the example shown in FIG. 2a, the nozzle 106 can be moved together with the mixing unit 104 along a rail 108 (not shown), in order to generate a spatial arrangement of printable mass 114 on a base plate 203.

FIG. 2a further shows a heating unit 207 (e.g. a heating plate), which is configured to move as a function of the position of the nozzle 106. In particular, the heating unit 207, as shown in FIG. 2a, can be connected via fastening means 206 to the nozzle 106 or to a press head, which comprises the nozzle 106, so that the heating unit 207 (in the direction of movement of the nozzle 106) can be guided behind the nozzle 106. It can thus be achieved that thermal energy is supplied to the printable mass 114, which has been extruded from the nozzle 106, immediately after the extrusion. In particular, the extruded or expelled printable mass 114 can be selectively baked by means of a heated heating unit 207.

The control unit 120 can be configured to control the heating unit 207 by way of a control signal 211. In particular, a quantity of thermal energy, which is generated by the heating unit 207, or a temperature of the heating unit 207, can be changed. The heating unit 207 can be controlled as a function of a type and/or as a function of a quantity of extruded printable mass 114, for instance. A rapid and targeted cooking (in particular baking) of printable mass 114 can thus be achieved by means of a heating unit 207 arranged downstream of the nozzle 106.

FIG. 2b shows a heating unit 207, which can be rotated about the nozzle 106 or about the press head (see arrow 216). By suitably rotating the heating unit 207, it is possible for the heating unit 207 to selectively cook or bake the extruded printable mass 114 immediately following the extrusion of the printable mass 114 even with changes in direction of the nozzle 106.

FIG. 3a shows a top view (left side) and a side view (right side) of a ring-shaped heating unit 207, which is arranged around the nozzle 106. By means of the arrangement shown in FIG. 3a, it can be efficiently ensured that printable mass 114 can be cooked (in particular baked) by the heating unit 207 immediately following extrusion.

The heating unit 207 shown in FIG. 3b furthermore comprises a plurality of heating segments 307, which can each be activated individually by the control unit 120. In particular, the heating segments 307 can be activated as a function of a direction of movement of the nozzle 106. It is possible, if necessary, for only the one or more heating segments 307 to be heated, among which extruded printable mass 114 is located at a specific point in time.

A heating unit 207 for a system 100 for producing a foodstuff 117 (in particular for a foodstuff press) is thus described. In such cases, the heating unit 207 is disposed directly adjacent to the nozzle 106, by means of which printable mass 114 is pressed out onto the foodstuff 117 to be created. The printable mass 114 can be obtained if necessary directly from a casing (e.g. a casing with a finished dough mass). To ensure that the heating unit 207 can cook (in particular bake) extruded printable mass 114 promptly after the extrusion, the heating unit 207 can be connected via fastening means 206 fixedly to a receiving device for the nozzle 106. This ensures that the heating unit 207 carries out the same movements as the nozzle 106. The strand of printable mass 114 extruded from the nozzle 106 and deposited on a base plate 203 can be selectively heated and thus baked immediately after extrusion.

The heating unit 207 can be considered to be a carriage, which is arranged downstream of the nozzle 106. The nozzle 106 moves first and the heating unit 207 follows the nozzle 106 (according to the direction of movement of the nozzle 106). In such cases the heating unit 207 is located as close as possible above the extruded printable mass 114, without coming into contact with the printable mass 114. This permits a high thermal transition.

The heating unit 207 and/or the system 100 can comprise ventilation means (not shown), which are configured to generate an air suction away from the heating unit 207 downwards and/or to the side (e.g. rearward). The heat transfer from the heating unit 207 to the printable mass 114 can therefore be improved. The ventilation means (in particular a suction system and/or a vacuum system) can be disposed in the base plate 203 and/or in a rear part of the system 100. An air suction toward the baseplate 203 and/or to the rear of the system 100 can thus be effected, which transports the heated air of the heating unit 207 to the printable mass 114.

As already presented above, as an alternative or in addition to heating via the heating unit 207, the spatial arrangement of printable mass 114 can overall be cooked by a cooking unit 107 of the system 100. In particular, the air in a cooking compartment can be heated. Furthermore, the baseplate 203 can be heated. A plurality of possibilities can thus be provided in order to cook the extruded printable mass 114.

The heating unit 207 can comprise a heating plate, which can be heated. In such cases a heating plate of the heating unit 207 is typically at least as wide as an extruded strand of printable mass 114. Furthermore, the heating plate typically has a greater length than width. A period of time for heating printable mass 114 can be adjusted by the length of the heating plate.

The heating unit 207 (in particular a heating plate of the heating unit 207) is typically smaller than the spatial arrangement of printable mass 114 to be cooked. In particular, the spatial arrangement of printable mass 114 can assume a first region of the base plate 203. The heating unit 207 (in particular the heating plate of the heating unit 207) can be such that it only covers a fraction of the first region (e.g. 30%, 20%, 10% or less). A selective and targeted heating of printable mass 114 can be effected in this way.

The heating plate of a heating unit 207 may have a coating of carbon nanotubes, in order to provide heating power for cooking printable mass 114. Furthermore, the heating plate can comprise a metal plate. Alternatively or in addition, the heating unit 207 can comprise a light source in the UV and/or IR range, in order to provide heating power for cooking printable mass 114 in a precise manner. In such cases a laser can be used as a light source, with which a relatively high focusing and/or intensity of heating power is permitted.

The heating plate of a heating unit 207 can comprise a flat surface which faces the printable mass 114. Alternatively, the surface of the heating plate can be adjusted to a shape of the extruded strand of printable mass 114. In particular, the surface of the heating plate can be concave toward the printable mass 114.

The heating unit 207 may thus comprise a plurality of different heating elements, by means of which thermal energy is supplied to the printable mass 114 in a variety of ways. In particular, the heating unit 207 can comprise a heating element (e.g. a UV or IR laser), by means of which thermal energy can be fed into the interior of the printable mass 114. Furthermore, the heating unit 207 can comprise a heating element (e.g. a thermal heating plate), by means of which thermal energy can be fed into the surface of the printable mass 114. An accelerated and higher-quality cooking process can be effected by combining various heating elements.

As shown in FIGS. 2 and 3, the heating unit 207 can be attached directly to an extrusion unit (in particular to a nozzle 106) of the system 100 by way of fastening means 206. The heating unit 207 (in particular a heating plate of the heating unit 207) can therefore simulate the precise movements of the nozzle 106. Furthermore, the heating unit 207 can be arranged at the height of the opening of the nozzle 106, in order to cook a printable mass 114 in the shortest possible time, while saving on energy.

In the example from FIG. 2a, the heating unit 207 is fixedly connected to the extrusion unit (i.e. to the nozzle 106). The heating plate of the heating unit 207 can be heated uniformly. In the example in FIG. 2b, the heating unit 207 is movable and can rotate about the nozzle 106 as a function of the movement of the nozzle 106. The movements of the nozzle 106 and the heating unit 207 are dependent here on a predefined geometry of the foodstuff 117 to be produced. By means of a suitable movement of the heating unit 207, it can be ensured that the heating unit 207 is always arranged downstream of the nozzle 106 in the direction of movement of the nozzle 106.

In the example from FIG. 3a, the heating unit 207 is not movable and is fastened fixedly to the extrusion unit (in particular to the nozzle 106). The heating unit 207 is however attached in a circular fashion about the nozzle 106, and thus enables a constant downstream heating of the extruded printable mass 114. This enables the heating plate of the heating unit 207 to be heated uniformly.

The heating unit 207 shown in FIG. 3b comprises individual heating segments 307, which are arranged in a circular manner around the nozzle 106. The heating segments 307 can be activated and heated individually. If the nozzle moves in the direction indicated by the arrow for instance, the heating segment 307 which is matched thereto (which faces the arrow) is heated. This selection and activation of one or more heating segments 307 are carried out as a function of the direction of movement of the nozzle 106. In such cases the direction of movement of the nozzle 106 depends on the geometry of the foodstuff 117 to be produced.

The heating unit 207 described in this document enables an immediate and selective heating of an extruded strand of printable mass 114. Relatively small quantities of printable mass 114 can thus be selectively heated. Furthermore, a parallelization of extrusion and cooking process is enabled. This results overall in an acceleration of the cooking process and in a reduction in the energy consumption. On account of a physical coupling with the nozzle 106, the heating unit 207 can be brought relatively close to printable mass 114, but without coming into contact with it. The energy consumption of the cooking process can be further reduced and the cooking time can be further shortened.

The present invention is not restricted to the exemplary embodiments shown. In particular, it should be noted that the description and the figures are only intended to illustrate the principle of the proposed devices and systems.

1-15. (canceled)

16. A device for a system for producing food, the device comprising:
a movable nozzle configured to expel a printable mass at various positions to produce a spatial configuration of the printable mass for food;
a movable heating unit configured to supply thermal energy to the printable mass having been expelled from said nozzle; and
a control unit configured:
to determine a recipe for producing the food, the recipe indicating position data with a plurality of positions at which the printable mass is to be expelled from said nozzle to produce the spatial configuration of the printable mass for the food; and
to move said movable nozzle and said movable heating unit as a function of the position data.

17. The device according to claim 16, wherein said movable heating unit is configured to follow a movement of said movable nozzle.

18. The device according to claim 16, which further comprises a surface to which the printable mass is applied, said movement of said movable nozzle being a movement lateral to said surface to which the printable mass is applied.

19. The device according to claim 16, which further comprises a fastener connecting said movable heating unit to said nozzle.

20. The device according to claim 16, wherein said movable heating unit includes an actuator for moving said heating unit around said nozzle, said control unit being configured to determine a direction of movement of said nozzle and to control said actuator as a function of the direction of movement of said nozzle.

21. The device according to claim 16, wherein said heating unit is disposed in a position relative to said nozzle to permit said heating unit to follow a movement of said nozzle at a predefined distance.

22. The device according to claim 16, wherein said heating unit is positioned relative to said nozzle to permit said heating unit to supply thermal energy to the printable mass having been expelled from said nozzle within a specific period of time after expulsion of the printable mass, and said specific period of time depends on a speed of movement of said nozzle.

23. The device according to claim 16, wherein said heating unit includes at least one heating element selected from the group consisting of a heatable heating plate and a light source configured to emit electromagnetic radiation in at least one of the UV or the IR range.

24. The device according to claim 16, wherein said heating unit includes a heating element emitting heat, and said heating element has a width being equal to or greater than a width of a strand of printable mass expelled by said nozzle and said heating element has a length being greater than said width of said heating element.

25. The device according to claim 16, wherein said heating unit has a ring-shaped structure enclosing said nozzle.

26. The device according to claim 16, wherein:
said heating unit includes a plurality of heating segments being separately controllable to transmit thermal energy to the expelled printable mass; and
said control unit is configured to activate said plurality of heating segments as a function of the position data.

27. The device according to claim 26, wherein said control unit is configured to activate said plurality of heating segments as a function of a direction of movement of said nozzle.

28. The device according to claim 16, wherein said heating unit is configured to heat air in an area surrounding said heating unit, and a device moves heated air from said heating unit to the expelled printable mass.

29. The device according to claim 16, wherein said heating unit is disposed at a vertical distance from the expelled printable mass being equal to or greater than a vertical distance between said nozzle and the expelled printable mass.

30. The device according to claim 16, wherein:
the recipe indicates at least one parameter for cooking the printable mass for producing the food;
the at least one parameter includes at least one of:
a quantity of thermal energy to be supplied to the printable mass,
a time instant at which thermal energy is to be supplied to the printable mass, or
a method with which thermal energy is to be supplied to the printable mass, and
said control unit is configured to control said heating unit as a function of said at least one parameter.

31. The device according to claim 16, wherein the printable mass has at least one of a deformable or viscous consistency or the printable mass includes a dough for a pastry.

32. The device according to claim 16, which further comprises:
a cooking unit configured to supply thermal energy to the spatial configuration of the printable mass as a whole;
the recipe indicates information for controlling said cooking unit; and
said control unit is configured to control said cooking unit as a function of the recipe.
